(19) United States
(12) Patent Application Publication
(10) Pub. No.: US 2026/0262067 A1
(43) Pub. Date: Sep. 3, 2026

(54) SIDELINK BEAMFORMING CONFIGURED USING PHYSICAL SIDELINK FEEDBACK CHANNEL

(71) Applicant: Lenovo (Singapore) Pte. Limited, Singapore (SG)

(72) Inventors: Karthikeyan Ganesan, Nauheim (DE); Vijay Nangia, Woodrdge, IL (US); Ravi Kuchibhotla, Chicago, IL (US)

(73) Assignee: Lenovo (Singapore) Pte. Limited, Singapore (SG)

(21) Appl. No.: 19/159,974

(22) PCT Filed: Mar. 6, 2024
(86) PCT No.: PCT/IB2024/052179

§ 371 Date: Aug. 26, 2025

Related U.S. Application Data
(60) Provisional application No. 63/489,742, filed on Mar. 11, 2023.

(51) Int. Cl. H04W 72/40; H04L 1/1829; H04W 72/044

(52) U.S. Cl. CPC H04W 72/40; H04L 1/1854; H04W 72/046

(57) ABSTRACT

Various aspects of the present disclosure relate to an apparatus for sidelink beamforming configured using PSFCH. The apparatus, such as a UE, receives a configuration indicating multiple physical sidelink feedback channel (PSFCH) occasions associated with physical sidelink shared channel (PSSCH) reception slots. The UE determines a PSFCH occasion of the multiple PSFCH occasions. The UE selects a transmit sidelink beam for sidelink feedback during the PSFCH occasion based on a PSSCH reception slot associated with the PSFCH occasion, where the transmit sidelink beam for the sidelink feedback corresponds to a receive sidelink beam for sidelink data during the PSSCH reception slot associated with the PSFCH occasion. The UE transmits the sidelink feedback using the selected transmit sidelink beam.

### RELATED APPLICATION

This application claims priority to U.S. Provisional Application Ser. No. 63/489,742 filed Mar. 11, 2023 entitled “Sidelink Beamforming Configured using Physical Sidelink Feedback Channel,” the disclosure of which is incorporated by reference herein in its entirety.

### TECHNICAL FIELD

The present disclosure relates to wireless communications, and more specifically to sidelink (SL) beamforming.

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

For the new radio (NR)-Uu interface in a wireless communications system, the synchronization signal block (SSB) random access control channel (RACH) correspondence mechanism for initial beam alignment is standardized. However, this type of correspondence is not available for the NR PC5 interface since not all UEs transmit SL-SSB (sidelink synchronization signal (SLSS)) transmissions. For vehicle-to-everything (V2X), the SLSS is only transmitted by the SyncRef UE to provide sync sources to all nearby UEs (e.g., not all UEs transmit SLSS). The NR V2X millimeter wave (mmWave) frequencies (FR2/FR3/FR4) introduce challenges, such as for sidelink beam and/or panel establishment for unicast transmission between a transmit (Tx) UE and a receive (Rx) UE, as well as beam and/or panel switching based on the measurement for unicast transmission, and sidelink beam recovery. Further, a SL-SSB transmission is not UE dedicated and is not part of the resource pool.

### SUMMARY

The present disclosure relates to methods, apparatuses, and systems that support sidelink beamforming configured using physical sidelink feedback channel (PSFCH). By utilizing the described techniques, a gNB can configure N-PSFCH occasions for M-physical sidelink shared channel (PSSCH) reception slots, where M=N, M>N, or M<N. A (pre) configuration contains the number of PSFCH occasions to be used for transmitting PSFCH containing a hybrid automatic repeat request acknowledgment (HARQ-ACK) and/or a channel state information (CSI) report for M-PSSCH and/or physical sidelink control channel (PSCCH) slots. A UE determines how to select the transmit sidelink beam for PSFCH in these PSFCH occasions, as well as how to associate the N-PSFCH occasions to the M-PSSCH reception slots.

In aspects of the described techniques for sidelink beamforming configured using PSFCH, there is a one-to-one mapping rule between PSSCH reception slots and PSFCH occasion, which provides that the UE transmitting the PSSCH using a transmit sidelink beam can receive the PSFCH using the corresponding receive sidelink beam (e.g., using the same spatial domain filter for reception of the PSFCH as was used for the transmission of the PSSCH). Aspects of this disclosure describes techniques for sidelink beamforming, such as beam establishment and best beam feedback reception for unicast with channel state information reference signal (CSI-RS) transmission. The described techniques also include aspects of sidelink beamforming for the transmission of first sidelink control information (SCI), second SCI, and PSSCH. The described techniques also include a configuration of a sidelink dedicated transmission configuration indicator (TCI) table for unicast, a TCI and/or cast type state indication in SCI for receiving the second SCI and PSSCH, and further, aspects of beamforming for PSFCH transmission.

In some implementations of the method and apparatuses described herein, a UE receives a configuration indicating multiple PSFCH occasions associated with PSSCH reception slots, and the UE determines a PSFCH occasion of the multiple PSFCH occasions. The UE selects a transmit sidelink beam for sidelink feedback during the PSFCH occasion based at least in part on a PSSCH reception slot associated with the PSFCH occasion, where the transmit sidelink beam for the sidelink feedback corresponds to a receive sidelink beam for sidelink data during the PSSCH reception slot associated with the PSFCH occasion. The UE transmits the sidelink feedback using the selected transmit sidelink beam.

Some implementations of the method and apparatuses described herein may further include the UE determines the PSFCH occasion based at least in part on the PSSCH reception slot associated with the PSFCH occasion. The UE determines the PSFCH occasion based at least in part on one or more of the PSSCH reception slots. The UE transmits the sidelink feedback as a HARQ-ACK using the selected transmit sidelink beam. The UE transmits the sidelink feedback as a CSI report using the selected transmit sidelink beam. The UE selects the transmit sidelink beam for the PSFCH occasion based at least in part on a one-to-one mapping of the multiple PSFCH occasions to the PSSCH reception slots. The UE determines the PSFCH occasion based at least in part on an ascending order of the multiple PSFCH occasions in the one-to-one mapping of the multiple PSFCH occasions to the ascending order of the PSSCH reception slots. The UE selects a subset number of multiple HARQ-ACKs or PSFCHs in frequency domain to be transmitted for an equal number of the PSSCH reception slots in the PSFCH occasion using the selected transmit sidelink beam. The UE determines the PSFCH occasion as an earliest of a subset number of the multiple PSFCH occasions associated with the PSSCH reception slot. The UE selects a subset number of multiple HARQ-ACKs or PSFCHs in frequency domain to be transmitted for a greater number of the PSSCH reception slots in the PSFCH occasion using the selected transmit sidelink beam. The UE selects a subset number of multiple HARQ-ACKs or PSFCHs in frequency domain to be transmitted for a lesser number of the PSSCH reception slots in the PSFCH occasion using the selected transmit sidelink beam. The UE selects a subset number of multiple HARQ-ACKs or PSFCHs in frequency domain based at least in part on a sidelink priority of the PSSCH reception slot. The UE selects the transmit sidelink beam based at least in part on the receive sidelink beam being a most recent receive sidelink beam associated with the PSSCH reception slot.

In some implementations of the method and apparatuses described herein, a gNB transmits, to a UE, a configuration indicating multiple PSFCH occasions associated with PSSCH reception slots, where the UE selects a transmit sidelink beam for sidelink feedback during a PSFCH occasion based at least in part on a PSSCH reception slot associated with the PSFCH occasion. The gNB receives the sidelink feedback using a receive sidelink beam that corresponds to the selected transmit sidelink beam.

Some implementations of the method and apparatuses described herein may further include the transmit sidelink beam for the sidelink feedback corresponds to the receive sidelink beam during the PSSCH reception slot associated with the PSFCH occasion. The PSFCH occasion is based at least in part on the PSSCH reception slot associated with the PSFCH occasion. The PSFCH occasion is based at least in part on one or more of the PSSCH reception slots. The processor is configured to cause the apparatus to receive the sidelink feedback as a HARQ-ACK using the receive sidelink beam. The gNB receives the sidelink feedback as a CSI report using the receive sidelink beam. The transmit sidelink beam for the PSFCH occasion is selected based at least in part on a one-to-one mapping of the multiple PSFCH occasions to the PSSCH reception slots. The PSFCH occasion is determined based at least in part on an ascending order of the multiple PSFCH occasions in the one-to-one mapping of the multiple PSFCH occasions to the ascending order of the PSSCH reception slots. A subset number of multiple HARQ-ACKs or PSFCHs in frequency domain is selected for an equal number of the PSSCH reception slots in the PSFCH occasion. The PSFCH occasion is determined as an earliest of a subset number of the multiple PSFCH occasions associated with the PSSCH reception slot. A subset number of multiple HARQ-ACKs or PSFCHs in frequency domain is selected for a greater number of the PSSCH reception slots in the PSFCH occasion. A subset number of multiple HARQ-ACKs or PSFCHs in frequency domain is selected for a lesser number of the PSSCH reception slots in the PSFCH occasion. A subset number of multiple HARQ-ACKs or PSFCHs in frequency domain is selected based at least in part on a sidelink priority of the PSSCH reception slot. The transmit sidelink beam is selected based at least in part on the receive sidelink beam being a most recent receive sidelink beam associated with the PSSCH reception slot.

### BRIEF DESCRIPTION OF THE DRAWINGS

FIG. 1 illustrates an example of a wireless communications system that supports sidelink beamforming configured using PSFCH in accordance with aspects of the present disclosure.

FIG. 2 illustrates an example of PC5 unicast links, as related to sidelink beamforming configured using PSFCH in accordance with aspects of the present disclosure.

FIG. 3 illustrates an example of a Layer-2 link establishment procedure, as related to sidelink beamforming configured using PSFCH in accordance with aspects of the present disclosure.

FIG. 4 illustrates an example of PSFCHs for HARQ feedback associated with different transmissions, as related to sidelink beamforming configured using PSFCH in accordance with aspects of the present disclosure.

FIG. 5 illustrates an example of mapping between a PSSCH and a PSFCH occasion, which supports sidelink beamforming configured using PSFCH in accordance with aspects of the present disclosure.

FIG. 6 illustrates an example of mapping between a PSSCH and a PSFCH occasion with different UEs, which supports sidelink beamforming configured using PSFCH in accordance with aspects of the present disclosure.

FIG. 7 illustrates an example of a selection of a subset of PSFCHs according to the same or similar PSFCH transmit beam, which supports sidelink beamforming configured using PSFCH in accordance with aspects of the present disclosure.

FIG. 8 illustrates an example of a selection of a PSFCH transmit beam according to a recent PSSCH receive updated beam for the same UE pair, which supports sidelink beamforming configured using PSFCH in accordance with aspects of the present disclosure.

FIG. 9 illustrates an example of a groupcast beam sweeping occasion mapped to a PSFCH occasion, which supports sidelink beamforming configured using PSFCH in accordance with aspects of the present disclosure.

FIGS. 10 and 11 illustrate an example of a block diagram of devices that supports sidelink beamforming configured using PSFCH in accordance with aspects of the present disclosure.

FIGS. 12-14 illustrate flowcharts of methods that support sidelink beamforming configured using PSFCH in accordance with aspects of the present disclosure.

### DETAILED DESCRIPTION

In a wireless communications system for sidelink communication between UEs, it has not been established or made clear how to configure a UE specific SSB-RACH within a resource pool for beam establishment. Current configurations do not provide an indication as to when sidelink beam establishment is performed, such as during PC5-radio resource control (RRC) unicast link establishment, or after the PC5-RRC unicast link establishment, or how to configure transmit sidelink beams used for the transmission of PSFCH (i.e., L1 HARQ feedback channel) for the associated reception of PSSCH. In a distributed system, there may be multiple unicast pairs of devices, and one UE may have multiple unicast links to other UEs. However, there are limitations in the maximum number of analog beams supported for a UE in a reception slot, and the given capability of any one UE depends on the number of radio frequency (RF) signal chains.

In aspects of sidelink beamforming configured using PSFCH, this disclosure describes techniques for sidelink beamforming, such as beam establishment and best beam feedback reception for unicast with CSI-RS transmission. The described techniques also include aspects of sidelink beamforming for the transmission of first SCI, second SCI, and PSSCH. The described techniques for aspects of sidelink beamforming also include a configuration of a sidelink dedicated TCI table for unicast, a TCI and/or cast type state indication in SCI for receiving the second SCI and PSSCH, and further, aspects of beamforming for PSFCH transmission.

A conventional wireless communications system does not take into account beamformed transmission and reception, having one PSFCH occasion mapped to M-PSSCH slots. This typical mapping rule considers that omni-directional transmission and the ascending order of the PSSCH slots is mapped to the ascending order of the PSFCH physical resource blocks (PRBs) in one PSFCH occasion in the same subchannel in which the PSSCH was transmitted. In aspects of the described disclosure for sidelink beamforming configured using PSFCH, there is a one-to-one mapping rule between PSSCH slots and PSFCH occasion, which provides that the UE transmitting the PSSCH using a transmit sidelink beam can receive the PSFCH using the corresponding receive sidelink beam (e.g., using the same spatial domain filter for reception of the PSFCH as was used for the transmission of the PSSCH). If the UE does not perform beamforming, then the coverage is limited in FR2 (i.e., mmWave spectrum).

In aspects of the described techniques for sidelink beamforming configured using PSFCH, a gNB can configure N-PSFCH occasions for M-PSSCH reception slots, where M=N, M>N, or M<N. A (pre) configuration contains the number of PSFCH occasions to be used for transmitting PSFCH containing HARQ-ACK and/or a CSI report for M-PSSCH and/or PSCCH slots. A UE determines how to select the transmit sidelink beam for PSFCH in these PSFCH occasions, as well as how to associate the N-PSFCH occasions to the M-PSSCH reception slots.

Aspects of the present disclosure are described in the context of a wireless communications system. Aspects of the present disclosure are further illustrated and described with reference to device diagrams and flowcharts.

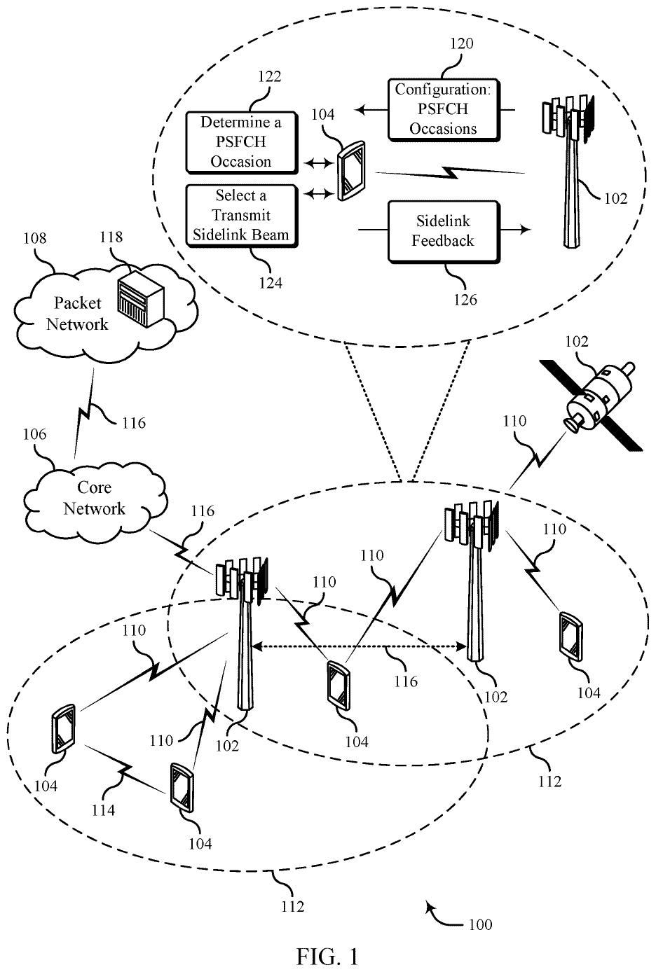

FIG. 1 illustrates an example of a wireless communications system 100 that supports sidelink beamforming configured using PSFCH in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite (e.g., a non-terrestrial station (NTS)) associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, N6, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, N6, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 and the UEs 104 are operable to implement various aspects of sidelink beamforming configured using PSFCH, as described herein. For instance, a network entity 102 (e.g., a gNB) communicates (e.g., transmits) a configuration 120 that includes various information, such as an indication of multiple PSFCH occasions associated with PSSCH reception slots. A UE 104 receives the configuration 120 indicating the multiple PSFCH occasions associated with the PSSCH reception slots, and the UE determines 122 a PSFCH occasion of the multiple PSFCH occasions. The UE 104 also selects 124 a transmit sidelink beam for sidelink feedback during the PSFCH occasion based on a PSSCH reception slot associated with the PSFCH occasion, where the transmit sidelink beam for the sidelink feedback corresponds to a receive sidelink beam for sidelink data during the PSSCH reception slot associated with the PSFCH occasion. The UE 104 communicates (e.g., transmits), and the gNB receives, the sidelink feedback 126 using the selected transmit sidelink beam.

With reference to sidelink resource allocation, at least two sidelink resource allocation modes are defined, such as a Mode 1 includes a base station schedules sidelink resource(s) to be used by a UE for sidelink transmissions, and a Mode 2 includes a UE determines (i.e., given the base station does not schedule), the sidelink transmission resource(s) within sidelink resources configured by a base station or network entity, or pre-configured sidelink resources. The definition of sidelink resource allocation Mode 2 covers: a) a UE autonomously selects a sidelink resource for transmission, and b) a UE assists sidelink resource selection for other UE(s), as a functionality of inter-UE coordination.

With reference to a UE procedure for transmitting PSFCH with control information, a UE can be indicated by an SCI format scheduling a PSSCH reception to transmit a PSFCH with HARQ-ACK information in response to the PSSCH reception. The UE provides HARQ-ACK information that includes ACK or negative acknowledge (NACK), or only NACK. A UE can be provided, by sl-PSFCH-Period, a number of slots in a resource pool for a period of PSFCH transmission occasion resources. If the number is zero, PSFCH transmissions from the UE in the resource pool are disabled. A UE can be enabled, by inter-UECoordinationScheme2, to transmit a PSFCH with conflict information in a resource pool. The UE can determine, based on an indication by a SCI format 1-A, a set of resources that includes one or more slots and resource blocks that are reserved for PSSCH transmission. If the UE determines a conflict for a reserved resource for PSSCH transmission, the UE provides conflict information in a PSFCH. A UE expects that a slot

$${t}_{k}^{′ SL} ( 0 \leq k < {T}_{max}^{′} )$$

has a PSFCH transmission occasion resource if k mod

$${N}_{PSSCH}^{PSFCH} = 0 , where {t}_{k}^{′ SL} , and {T}_{max}^{′}$$

is a number of slots that belong to the resource pool within 10240 msec, and

$${N}_{PSSCH}^{PSFCH}$$

is provided by the sl-PSFCH-Period.

A UE can be indicated by higher layers so as not to transmit a PSFCH that includes HARQ-ACK information in response to a PSSCH reception. If a UE receives a PSSCH in a resource pool and the HARQ feedback enabled/disabled indicator field in an associated SCI format 2-A/2-B/2-C has a value 1, then the UE provides the HARQ-ACK information in a PSFCH transmission in the resource pool. The UE transmits the PSFCH in a first slot that includes PSFCH resources and is at least a number of slots, provided by sl-MinTimeGapPSFCH, of the resource pool after a last slot of the PSSCH reception.

A UE is provided by sl-PSFCH-RB-Set a set of

$${M}_{PRB , set}^{PSFCH}$$

PRBs in a resource pool for PSFCH transmission with HARQ-ACK information in a PRB of the resource pool. A UE can be provided by sl-PSFCH-Conflict-RB-Set a set of

$${M}_{PRB , set}^{PSFCH}$$

PRBS in a resource poor for PSFCH transmission with conflict information in a PRB of the resource pool. A UE expects that different PRBs are (pre) configured for conflict information and HARQ-ACK information. For a number of N_{subch} sub-channels for the resource pool, provided by sl-NumSubchannel, and a number of PSSCH slots associated with a PSFCH slot that is less than or equal to

$${N}_{PSSCH}^{PSFCH} ,$$

the UE allocates the

$$[ ( i + j \cdot {N}_{PSSCH}^{PSFCH} ) \cdot {M}_{subch , slot}^{PSFCH} , ( i + 1 + j \cdot {N}_{PSSCH}^{PSFCH} ) \cdot {M}_{subch , slot}^{PSFCH} - 1 ]$$

PRBs from the

$${M}_{PRB , set}^{PSFCH}$$

PRBs to slot i among the PSSCH slots associated with the PSFCH slot and sub-channel j, where

$${M}_{subch , slot}^{PSFCH} = {M}_{PRB , set}^{PSFCH} / ( {N}_{subch} \cdot {N}_{PSSCH}^{PSFCH} ) , 0 \leq i < {N}_{PSSCH}^{PSFCH} , 0 \leq j < {N}_{subch} ,$$

and the allocation starts in an ascending order of i and continues in an ascending order of j. The UL expects that

$${M}_{PRB , set}^{PSFCH}$$

is a multiple of

$${N}_{subch} \cdot {N}_{PSSCH}^{PSFCH} .$$

The second OFDM symbol l′ of PSFCH transmission in a slot is defined as l′=sl-StartSymbol+sl-LengthSymbols−2.

A UE determines a number of PSFCH resources available for multiplexing HARQ-ACK or conflict information in a PSFCH transmission as

$${R}_{PRB , CS}^{PSFCH} = {N}_{type}^{PSFCH} \cdot {M}_{subch , slot}^{PSFCH} \cdot {N}_{CS}^{PSFCH} where {N}_{CS}^{PSFCH}$$

is a number of cyclic shift pairs for the resource pool provided by sl-NumMuxCS-Pair and, based on an indication by sl-PSFCH-CandidateResourceType: (1) if sl-PSFCH-CandidateResourceType is configured as startSubCH,

$${N}_{type}^{PSFCH} = 1$$

and the

$${M}_{subch , slot}^{PSFCH}$$

PRBS are associated with the starting sub-channel of the corresponding PSSCH; (2) if sl-PSFCH-CandidateResourceType is configured as allocSubCH,

$${N}_{type}^{PSFCH} = {N}_{subch}^{PSSCH}$$

and the

$${N}_{subch}^{PSSCH} .$$

PRBs are associated with the

$${N}_{subch}^{PSSCH}$$

sub-channels of the corresponding PSSCH; and for conflict information, the corresponding PSSCH is determined based on PSFCHOccasionScheme2.

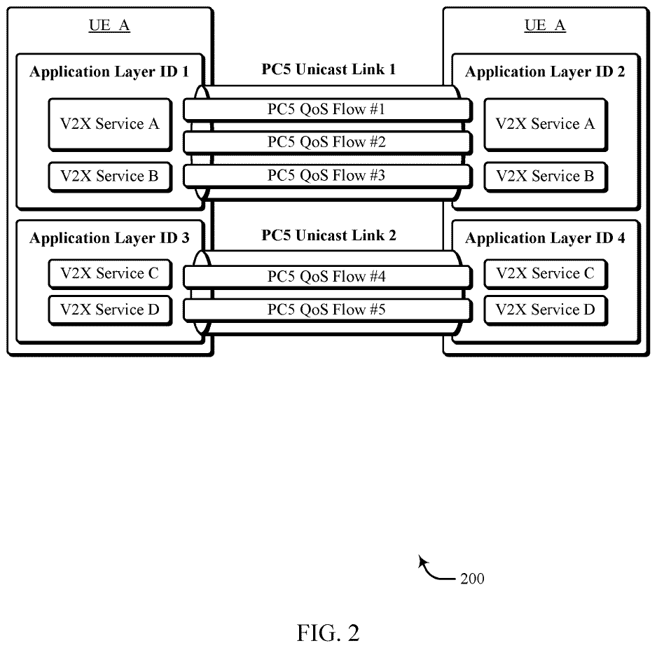

FIG. 2 illustrates an example 200 of PC5 unicast links, as related to sidelink beamforming configured using PSFCH. This disclosure takes into consideration information related to PC5 RRC unicast connection establishment, link maintenance, and V2X groupcast and/or broadcast mode of operation. A unicast mode of communication is only supported over NR based PC5 reference point.

The following principles apply when the V2X communication is carried over a PC5 unicast link. A PC5 unicast link between two UEs allows V2X communication between one or more pairs of peer V2X services in these UEs. All V2X services in the UE using the same PC5 unicast link use the same application layer identifier (ID). Noting that an application layer ID can change in time, such as due to privacy. This does not cause a re-establishment of a PC5 unicast link, and the UE can trigger a link identifier update procedure. One PC5 unicast link supports one or more V2X service types if these V2X service types are at least associated with the pair of peer application layer IDs for this PC5 unicast link.

As illustrated in this example 200, UE A and UE B have two PC5 unicast links, one between peer application layer ID 1/UE A and application layer ID 2/UE B, and one between peer application layer ID 3/UE A and application layer ID 4/UE B. Noting that a source UE is not required to know whether different target application layer IDs over different PC5 unicast links belong to the same target UE, where a PC5 unicast link supports V2X communication using a single network layer protocol (e.g. Internet protocol (IP) or non-IP). Further, a PC5 unicast link supports per-flow QoS model, and if multiple V2X service types use a PC5 unicast link, one PC5 QoS Flow identified by paging frame index (PFI) may be associated with more than one V2X service type.

When the application layer in the UE initiates data transfer for a V2X service type which requires unicast mode of communication over PC5 reference point, the UE shall reuse an existing PC5 unicast link if the pair of peer application layer IDs and the network layer protocol of this PC5 unicast link are identical to those required by the application layer in the UE for this V2X service, and modify the existing PC5 unicast link to add this V2X service type. Further, the UE shall trigger the establishment of a new PC5 unicast link. After successful PC5 unicast link establishment, UE A and UE B use the same pair of Layer-2 IDs for subsequent PC5-S signaling message exchange and V2X service data transmission. The V2X layer of the transmitting UE indicates to the AS layer whether a transmission is for a PC5-S signaling message (i.e. a direct communication request or accept, a link identifier update request, response and/or ACK, a disconnect request or response, a link modification request or accept, or a keep-alive/ACK) or V2X service data.

For every PC5 unicast link, a UE self-assigns a distinct PC5 link identifier that uniquely identifies the PC5 unicast link in the UE for the lifetime of the PC5 unicast link. Each PC5 unicast link is associated with a unicast link profile which includes an application layer ID and Layer-2 ID of UE A, an application layer ID and Layer-2 ID of UE B, a network layer protocol used on the PC5 unicast link, and the information about PC5 QoS flow(s). For each PC5 QoS flow, the PC5 QoS context and the PC5 QoS rule(s) are defined. For privacy reasons, the application layer IDs and Layer-2 IDs may change during the lifetime of the PC5 unicast link and, if so, shall be updated in the unicast link profile accordingly. The UE uses PC5 link identifier to indicate the PC5 unicast link to the V2X application layer. Therefore, the V2X application layer identifies the corresponding PC5 unicast link even if there are more than one unicast link associated with one V2X service type (e.g., the UE establishes multiple unicast links with multiple UEs for a same V2X service type).

The unicast link profile shall be updated accordingly after a Layer-2 link modification for an established PC5 unicast link, or Layer-2 link identifier update. Upon receiving an indication from the AS layer that the PC5-RRC connection was released due to radio link failure (RLF), the V2X layer in the UE locally releases the PC5 unicast link associated with this PC5-RRC connection. The AS layer uses PC5 link identifier to indicate to the V2X layer of the PC5 unicast link whose PC5-RRC connection was released. When the PC5 unicast link has been released, the V2X layer of each UE for the PC5 unicast link informs the AS layer that the PC5 unicast link has been released. The V2X layer uses PC5 link identifier to indicate the released unicast link.

Further aspects of the described techniques take into consideration unicast mode V2X communication and Layer-2 link establishment over PC5 reference point. To perform unicast mode of V2X communication over PC5 reference point, the UE is configured with the related information.

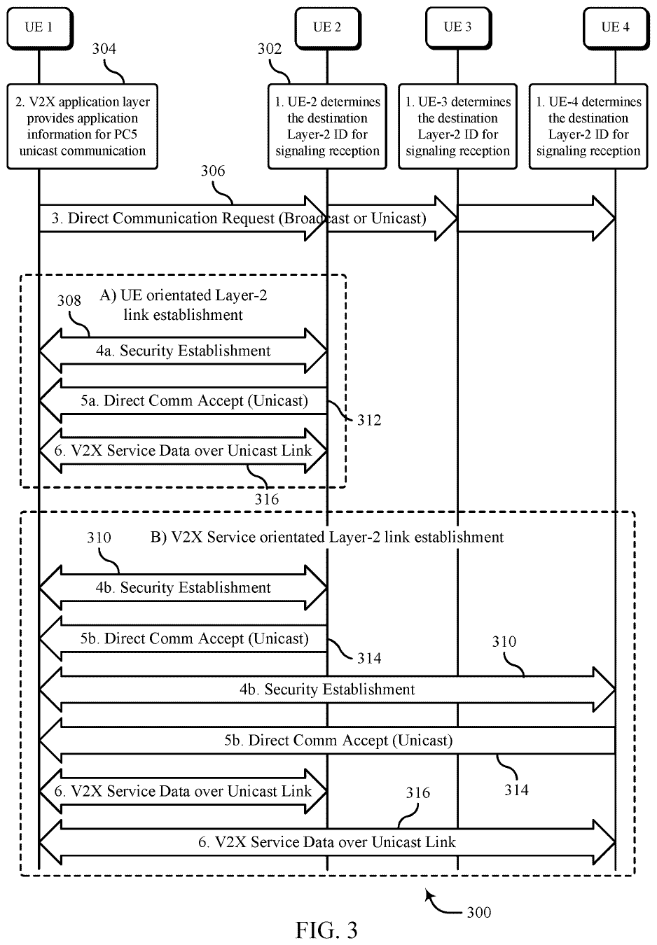

FIG. 3 illustrates an example 300 of a Layer-2 link establishment procedure, as related to sidelink beamforming configured using PSFCH. In this example 300 of a Layer-2 link establishment procedure, the UE(s) determine at 302 (step 1) the destination Layer-2 ID for signaling reception for PC5 unicast link establishment. In this implementation, the destination Layer-2 ID is configured with the UE(s). At 304 (step 2), the V2X application layer in UE-1 provides application information for PC5 unicast communication. The application information includes the V2X service type(s) and the application Layer ID of the initiating UE. The target UE application Layer ID may be included in the application information. The V2X application layer in UE-1 can provide V2X application requirements for this unicast communication, and the UE-1 determines the PC5 QoS parameters and PFI. If the UE-1 decides to reuse the existing PC5 unicast link, the UE triggers the Layer-2 link modification procedure.

At 306 (step 3) the UE-1 sends a direct communication request message (broadcast or unicast) to initiate the unicast Layer-2 link establishment procedure. The direct communication request message includes source user information of the initiating UE application layer ID (i.e., UE-1 application layer ID). If the V2X application layer provided the target UE application layer ID in step 2, the information includes target user information of the target UE application layer ID (i.e., UE-2 application layer ID). Additionally, the information includes V2X service information about the V2X service type(s) requesting Layer-2 link establishment, and security information for the establishment of security. Noting that the security information and the necessary protection of the source user info and target user info. The source Layer-2 ID and destination Layer-2 ID used to send the direct communication request message are determined, and the destination Layer-2 ID may be broadcast or unicast Layer-2 ID. When unicast Layer-2 ID is used, the target user info shall be included in the direct communication request message. The UE-1 sends the direct communication request message via PC5 broadcast or unicast using the source Layer-2 ID and the destination Layer-2 ID.

Security with the UE-1 is established at 308 (step 4a) if the target user info is included in the direct communication request message, the target UE (i.e., UE-2), responds by establishing the security with UE-1, or at 310 (step 4b) if the target user info is not included in the direct communication request message, the UEs that are interested in using the announced V2X service type(s) over a PC5 unicast link with UE-1 responds by establishing the security with UE-1. Noting that the signaling for the security procedure is defined. When the security protection is enabled, UE-1 sends the following information to the target UE: if IP communication is used, then an IP address configuration for IP communication, and IP address configuration is required for this link and indicates one of the following values: “IPv6 Router” if the IPv6 address allocation mechanism is supported by the initiating UE (i.e., acting as an IPv6 router), or “IPv6 address allocation not supported” if the IPv6 address allocation mechanism is not supported by the initiating UE.

A link local IPv6 address is a link-local IPv6 address formed locally if the UE-1 does not support the IPv6 IP address allocation mechanism (i.e., the IP address configuration indicates “IPv6 address allocation not supported”. The QoS information about PC5 QoS flow(s) to be added includes, for each PC5 QoS flow, the PFI, the corresponding PC5 QoS parameters (i.e., PQI and conditionally other parameters, such as maximum flow bit rate (MFBR)/guaranteed flow bit rate (GFBR), etc.) and the associated V2X service type(s). The source Layer-2 ID used for the security establishment procedure is determined, and the destination Layer-2 ID is set to the source Layer-2 ID of the received direct communication request message. Upon receiving the security establishment procedure messages, the UE-1 obtains the peer UE Layer-2 ID for future communication, for signaling, and data traffic for this unicast link.

A direct communication accept message is sent to the UE-1 by the target UE(s) that has successfully established security with UE-1 at 312 (step 5a) for UE oriented Layer-2 link establishment. If the target user info is included in the direct communication request message, the target UE (i.e., UE-2) responds with a direct communication accept message if the application layer ID for UE-2 matches. The established security at 314 (step 5b) for V2X service oriented Layer-2 link establishment. If the target user info is not included in the direct communication request message, the UEs that are interested in using the announced V2X service(s) respond to the request by sending a direct communication accept message (UE-2 and UE-4 in the figure). The direct communication accept message includes source user information, such as the application layer ID of the UE sending the direct communication accept message, and includes QoS information about PC5 QoS flow(s) requested by UE-1.

For each PC5 QoS flow, the PFI and the corresponding PC5 QoS parameters (i.e., PQI and conditionally other parameters such as MFBR/GFBR, etc.). If IP communication is used, the IP address configuration for IP communication, the IP address configuration is required for this link and indicates one of the following values: “IPv6 Router” if IPv6 address allocation mechanism is supported by the target UE (i.e., acting as an IPv6 Router), or “IPv6 address allocation not supported” if IPv6 address allocation mechanism is not supported by the target UE. The link local IPv6 address is formed locally if the target UE does not support the IPv6 IP address allocation mechanism (i.e., the IP address configuration indicates “IPv6 address allocation not supported”, and UE-1 included a link-local IPv6 address in the direct communication request message. The target UE shall include a non-conflicting link-local IPv6 address.

If both UEs (i.e., the initiating UE and the target UE) selected to use link-local IPv6 address, they shall disable the duplicate address detection. Noting that when either the initiating UE or the target UE indicates the support of IPv6 router, a corresponding address configuration procedure would be carried out after the establishment of the Layer 2 link, and the link-local IPv6 addresses are ignored. The V2X layer of the UE that established PC5 unicast link passes the PC5 link identifier assigned for the unicast link and the PC5 unicast link related information down to the AS layer. The PC5 unicast link related information includes Layer-2 ID information (i.e. source Layer-2 ID and destination Layer-2 ID) and the corresponding PC5 QoS parameters. This enables the AS layer to maintain the PC5 link identifier together with the PC5 unicast link related information.

At 316 (step 6) the V2X service data is transmitted over the established unicast link. The PC5 link identifier, and PFI are provided to the AS layer, together with the V2X service data. Optionally and in addition, the Layer-2 ID information (i.e. source Layer-2 ID and destination Layer-2 ID) is provided to the AS layer. Noting that it is up to UE implementation to provide the Layer-2 ID information to the AS layer. The UE-1 sends the V2X service data using the source Layer-2 ID (i.e., the UE-1 Layer-2 ID for this unicast link) and the destination Layer-2 ID (i.e., the peer UE Layer-2 ID for this unicast link). Noting that PC5 unicast link is bi-directional, and therefore the peer UE of UE-1 can send the V2X service data to UE-1 over the unicast link with UE-1.

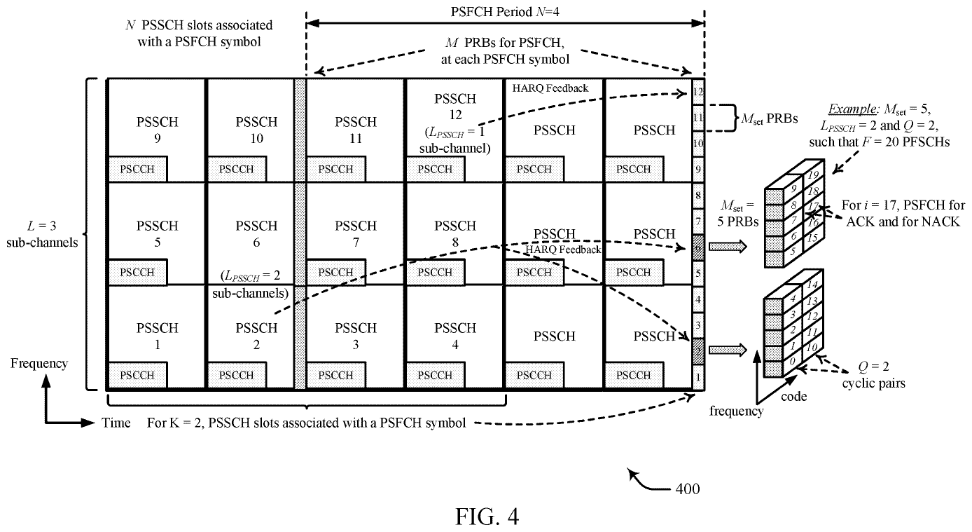

FIG. 4 illustrates an example 400 of PSFCHs for HARQ feedback associated with different transmissions, as related to sidelink beamforming configured using PSFCH. In aspects of sidelink beamforming configured using PSFCH, the terms eNB and/or gNB are used to indicate the base station, but are also replaceable by any other radio access node (e.g. a base station (BS), eNB, gNB, access point (AP), NR, etc.). Further the disclosed techniques are described mainly in the context of 5G NR. However, the proposed solutions, techniques, and methods are equally applicable to other mobile communication systems supporting serving cells and carriers that are configured for sidelink communication over a PC5 interface.

As described herein, a UE panel may be a logical entity with physical UE antennas mapped to the logical entity, and a mapping of physical UE antennas to the logical entity may depend on UE implementation. Depending on the implementation of a UE, the UE panel can include one or more functionalities in an operational role as a unit of antenna groups to control its transmit beam independently, a unit of antenna groups to control its transmission power independently, and/or a unit of antenna groups to control its transmission timing independently. The UE panel may be transparent to a gNB or peer UE(s). For certain conditions, a gNB, network entity, or peer UE can assume the mapping between the UE physical antennas to the logical entity (e.g., UE panel) may not be changed. For example, the condition may include until the next update or report from a UE, or comprise a duration of time over which the gNB or UE assumes there will be no change to the mapping. A UE may report its UE capability with respect to the UE panel to the gNB, network entity, and/or peer UE. The UE capability may include at least the number of UE panels. In another example, the UE capability may include a number of simultaneous transmissions over multiple panels or in multiple directions (e.g., corresponding to a number of uplink and/or sidelink TCI states, or spatial relations. In an implementation, the UE may support uplink or sidelink transmission from one beam within a panel, or with multiple panels, more than one beam (one beam per panel) may be used for uplink or sidelink transmission. In another implementation, more than one beam per panel may be supported and used for uplink or sidelink transmission.

Aspects of the present disclosure include techniques to select a PSFCH transmit beam and PSFCH occasion, as well as the mapping between the PSSCH and the PSFCH occasion. In one or more implementations, a gNB can configure N-PSFCH occasions for M-PSSCH slots (where M=N, M>N, or M<N) and (pre) configuration contains the number of PSFCH occasions to be used for transmitting PSFCH containing a HARQ-ACK and/or a CSI report for M-PSSCH and/or PSCCH slots. The UE determines a one-to-one mapping rule between a PSSCH slot and a PSFCH occasion, which is a selection of the PSFCH occasion for transmitting PSFCH for one or more PSSCH reception slots. Then, the UE determines how to select the transmit beam for PSFCH in these PSFCH occasions and how to transmit PSFCHs using the transmit beam in response to a PSSCH receive beam used to receive in the PSSCH reception slot.

Combinations of different implementations are also considered, such as to associate one PSSCH transmission to multiple of the PSFCH occasions. Also, a one-to-one mapping between the PSFCH occasions and PSSCH reception slots, where the UE selects the ascending order of PSFCH occasion according to an ascending order of PSSCH reception slots. A dynamic indication by SCI contains a PSFCH occasion(s) index to be used for transmitting PSFCH containing a HARQ-ACK and/or a CSI report corresponding to the received PSSCH reception slot. An index indicating a maximum allowed latency for a PSFCH transmission from the (pre) configured list of allowed maximum latency, and one or more PSFCH occasions within the maximum allowed latency could be a candidate for PSFCH occasions. The UE can select one of the PSFCH occasions according to the priority rule or the ascending order of the PSSCH reception slots as described in the implementations.

In implementations, the M-PSSCH slots can be associated with N-PSFCH occasions for a UE using a one-to-one mapping, where the UE determines a PSFCH occasion number and/or time domain index from multiple (e.g., a plurality of) the PSFCH occasions for PSFCH transmission in response to a PSSCH reception according to the ascending order of the PSSCH reception slots (i.e., the UE can associate an ascending order of PSFCH occasions to the ascending order of the PSSCH reception slots). Accordingly, the number of PSFCH occasions can equal the number of PSSCH slots and/or the number of PSFCH transmit beams for a UE. For example, a UE can choose to transmit a PSFCH using the same transmit beam in which it receives a PSSCH receive beam (e.g., transmit the PSFCH transmission with the same spatial domain filter used for reception of the PSSCH. Additionally, the UE can choose to transmit using a PSFCH transmit beam in a PSFCH occasion number from multiple of the SFCH occasions according to the ascending order of PSSCH reception slots using a respective received PSSCH receive beam (e.g., transmit the PSFCH transmission in a PSFCH occasion with the same spatial domain filter used for reception of the corresponding PSSCH in a PSCCH reception slot, where the association or mapping between the multiple PSFCH occasions and the PSSCH reception slots is according to the ascending order of PSSCH reception slots).

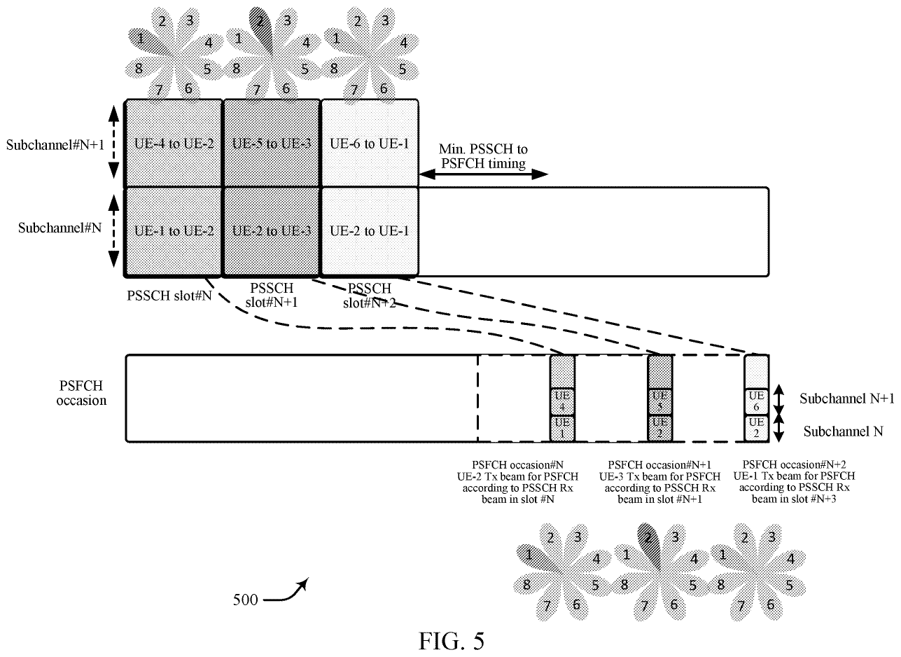

FIG. 5 illustrates an example 500 of mapping between a PSSCH and a PSFCH occasion, which supports sidelink beamforming configured using PSFCH in accordance with aspects of the present disclosure. In this example 500, M-PSSCH slots can be associated with N-PSFCH occasions in a resource pool to carry HARQ-ACKs and/or CSI reports. When a UE-2 receives PSSCH in slot #N using receive (Rx) beam #1, then UE-2 can select to transmit PSFCH using transmit (Tx) beam #1 in a first PSFCH transmission occasion (i.e., which full-fills the minimum time gap for processing a PSFCH transmission according to the PSSCH reception). Accordingly, the UE-2 can transmit PSFCHs to a UE-1 and a UE-4 in the first PSFCH occasion in a subchannel in which PSSCH was transmitted. Using beam correspondence, the UE-2's PSSCH in slot N+2 uses the same Tx beam to UE-1, where UE 2's PSSCH receives beams from UE-1 in slot N (e.g., UE-2 transmits the PSSCH transmission in slot N+2 with the same spatial domain filter used for reception of UE-1 PSSCH in slot N). In example implementations, when UE-2 changes the Tx beam in successive PSSCH slots (e.g., PSSCH transmission in slot N+1 using Tx beam x, and PSSCH transmission in slot N+2 using Tx beam y), a beam switching time duration may be used between the two PSSCH transmissions.

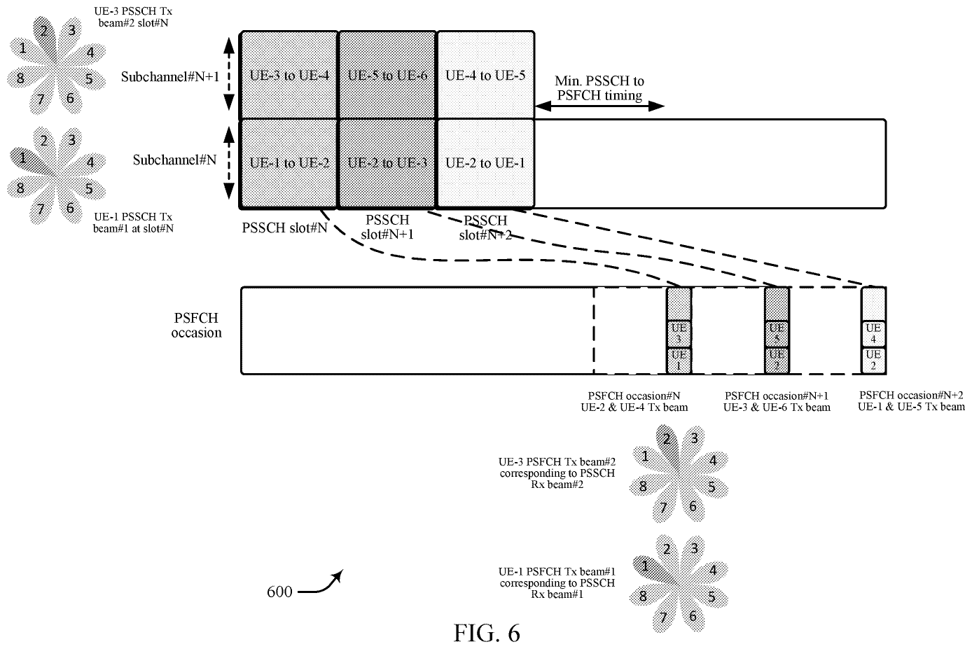

FIG. 6 illustrates an example 600 of mapping between a PSSCH and a PSFCH occasion with different UEs, which supports sidelink beamforming configured using PSFCH in accordance with aspects of the present disclosure. In this example 600, a UE-2 and a UE-4 can transmit PSFCHs in PSFCH occasion #N to a UE-1 and UE-3 respectively for PSSCH reception of slot #N. Each of the UE-2 and the UE-4 can use their Tx beams for PSFCH transmissions, and the selection of a PSFCH Tx beam of UE-2 and UE-4 corresponds to their respective PSSCH Rx beam. For example, UE-2 transmits the PSFCH in PSFCH occasion #N with the same first spatial domain filter used for reception of the corresponding PSSCH from UE-1 in PSSCH reception slot #N, and UE-4 transmits the PSFCH in PSFCH occasion #N with the same second spatial domain filter used for reception of the corresponding PSSCH from UE-3 in PSSCH reception slot #N. The first spatial domain filter may be different than the second spatial domain filter.

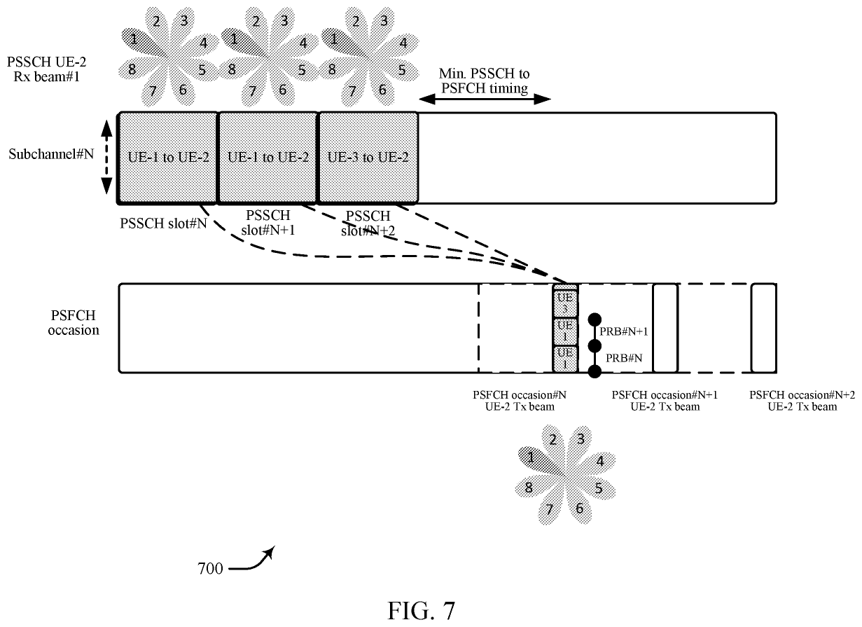

FIG. 7 illustrates an example 700 of a selection of a subset of PSFCHs according to the same or similar PSFCH transmit beam, which supports sidelink beamforming configured using PSFCH in accordance with aspects of the present disclosure. In this example 700, a UE can select a subset of PSFCHs having the same or similar PSFCH Tx beam to be transmitted in those PSFCH occasions for N-PSSCH reception slots, and the UE can select the earliest PSFCH occasion or the last PSFCH occasion according to the corresponding PSSCH reception slots. In this example, the UE-2 can select a subset of PSFCHs to be transmitted in PSFCH occasion #N to UE-1 and UE-3 using the same PSFCH Tx beam which was used to receive the corresponding PSSCHs (e.g., UE-2 transmits the PSFCHs with the same spatial domain filter used for reception of the corresponding PSSCHs from UE-1 and UE-3 in the same sub-channel) and each of these PSFCHs are mapped in an ascending order of PRBs according to an ascending order of PSSCH reception slots within the same subchannel in which PSSCH was received.

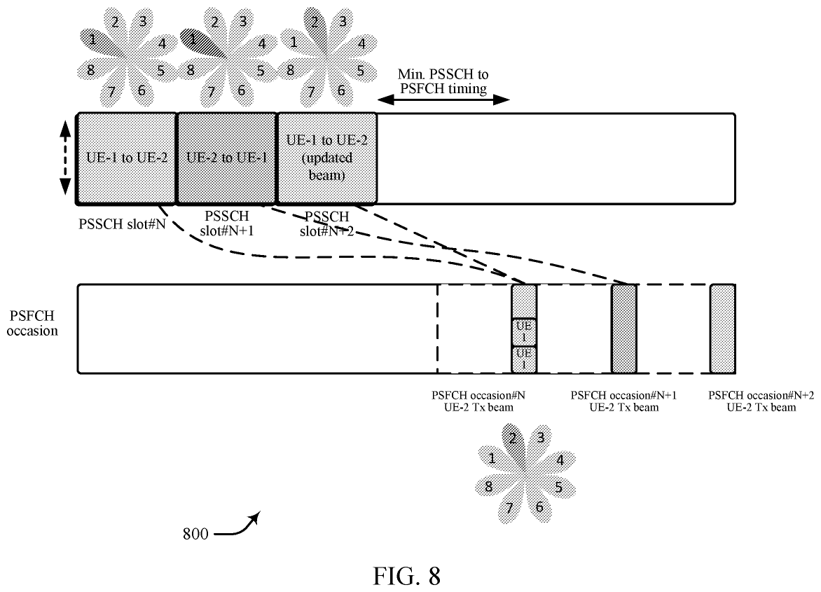

FIG. 8 illustrates an example 800 of a selection of a PSFCH transmit beam according to a recent PSSCH receive updated beam for the same UE pair, which supports sidelink beamforming configured using PSFCH in accordance with aspects of the present disclosure. In one or more implementations, the number of PSFCH occasions is less than the number of PSSCH slots and/or the number of PSFCH Tx beams for a UE. When the number of PSFCH occasions is less than the number of PSSCH slots for which HARQ-ACK reports need to be transmitted, then the UE may need to select a subset of PSFCHs to be transmitted using one or a combination of the following options. The UE can select a subset of PSFCHs having the same or similar PSFCH Tx beam to be transmitted in those PSFCH occasions. The UE can select a subset of PSFCHs according to the sidelink priority of the corresponding PSSCH reception. The UE can drop the one or more PSFCHs with a least priority value from the set of PSFCHs to be transmitted in those PSFCH occasions. Additionally, any combination of the above where the UE selects a subset of PSFCHs according to the sidelink priority of the PSSCH reception to transmit in those PSFCH occasions using their respective PSFCH Tx beam.

In one or more implementations, the number of PSFCH occasions is greater than the number of PSSCH slots and/or the number of PSFCH Tx beams for a UE. When the number of PSFCH occasions is more than the number of PSSCH slots for which HARQ-ACK reports need to be transmitted, then the UE can select PSFCH occasions to transmit a HARQ-ACK report according to the ascending order of the PSSCH reception slots. In another implementation, a UE may first select a subset of PSFCHs to be transmitted for M-PSSCH reception slots in a PSFCH occasion using the same or similar PSFCH Tx beam (or spatial transmission filter). Secondly, the UE can select an ascending order of PSFCH occasion number from the multiple PSFCH occasions according to the ascending order of the PSSCH reception slots for transmitting a HARQ-ACK report to different UEs using different PSFCH Tx beams in each of those occasions. In another implementation, the UE can use the most recent Rx beam of PSSCH in selecting the PSFCH Tx beam (e.g., UE-2 transmits the PSFCH with the same spatial domain filter used for reception of the most recent PSSCH from the same UE (UE-1)) and UE may select the earliest PSFCH occasion corresponding to the PSSCH reception slots, or may use the later PSFCH occasion corresponding to the PSSCH reception slots.

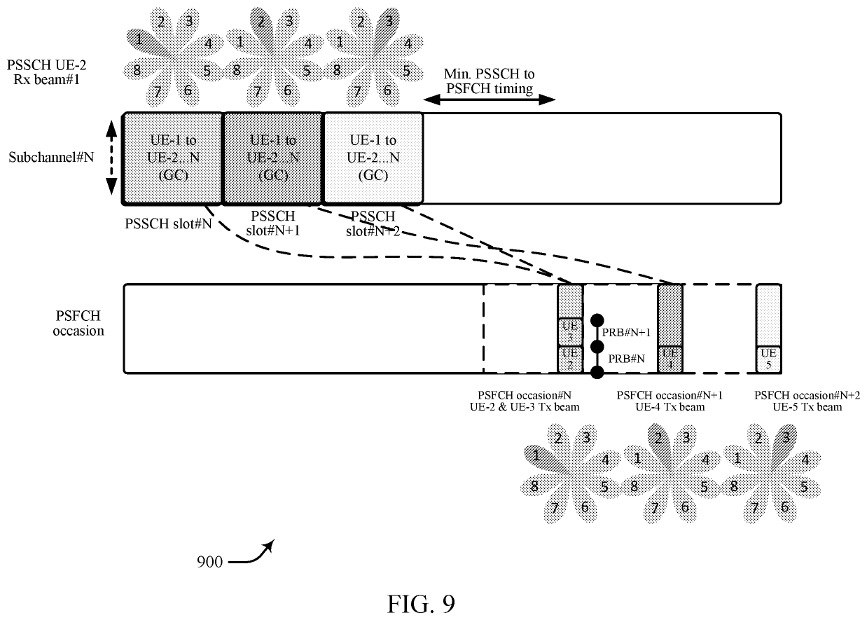

FIG. 9 illustrates an example 900 of a groupcast beam sweeping occasion mapped to a PSFCH occasion, which supports sidelink beamforming configured using PSFCH in accordance with aspects of the present disclosure. In one or more implementations, the described techniques provide for groupcast transmission and groupcast HARQ feedback reception. In an implementation for groupcast transmission, such as similar to the techniques described above, a one-to-one mapping between PSSCH occasion and PSFCH occasion can be generated. Assuming reciprocity, the Tx spatial filter for PSFCH should be the same as that used for receiving the PSSCH. The PSSCH UE uses the same beam (e.g., the same spatial domain filter) for receiving the PSFCH as that used for Tx of the PSSCH. In this example 500, since UE-1 performs a beam-sweeping groupcast transmission to UE-2, . . . . N, those that are part of the destination group, a subset of PSFCHs from UEs-2, . . . . N, which receives using the same PSSCH Tx beam beam #1 may transmit corresponding PSFCHs in the first PSFCH occasion #N. The UEs select their PSFCH PRBs within each PSFCH occasion #N according to the ascending order of a group member ID in that PSFCH occasion.

A gNB can configure one PUCCH resource in uplink at the end of the last PSFCH occasion. In the case of one PSSCH slot being associated to many PSFCH occasions, the frequency domain PSFCH PRB in each PSFCH occasion remains the same and is according to the ascending order of PSSCH slots to ascending order of PSFCH PRB in each PSFCH occasion. For a groupcast configured with option-2, a transmit UE can transmit a positive acknowledgement in the PUCCH resource to the gNB, such as when all UEs transmit positive acknowledgement in at least one of the PSFCH occasions associated to the groupcast PSSCH. The transmit UE can transmit a negative acknowledgement in the PUCCH resource to the gNB, such as when at least one UE's transmit negative acknowledgement in at least one of the PSFCH occasions is associated to the groupcast PSSCH slot. For a groupcast configured with option-1 containing common NACK in the PSFCH resource, a transmit UE can transmit a positive acknowledgement in the PUCCH resource to the gNB when there is no PSFCH reception in each of the configured PSFCH occasions, otherwise the transmit UE may transmit a negative acknowledgement. Similarly, for the unicast HARQ feedback, a transmit UE can transmit a positive acknowledgement in the PUCCH resource to the gNB, such as when a unicast UE transmits a positive acknowledgement in at least one of the PSFCH occasions associated to the unicast PSSCH slot, otherwise the transmit UE can transmit a negative acknowledgement.

Further, In one or more implementations, there exists a one-to-one mapping relationship between SSB occasions transmitted by a UE for initial beam pairing and PSFCH occasions to provide feedback on the best beam index implicitly. The PSFCH feedback includes any one of the following HARQ-ACK feedback or beam index or reference signal received power (RSRP) of one or more received beams with index. The PSFCH feedback format for carrying a CSI report may require more resource and hence, occupy the entire PSFCH PRBs in one or more subchannel(s) where PSSCH was transmitted. There could be a case where PSFCH carrying a CSI report and PSFCH carrying a HARQ feedback may be separately transmitted in different PRBs in the same or different subchannels where the corresponding PSSCH was transmitted.

Aspects of sidelink beamforming configured using PSFCH include and/or are directed to antenna panels and/or ports, quasi-collocation, TCI state, and spatial relation. In implementations described herein, the terms antenna, panel, and antenna panel are used interchangeably. An antenna panel may be hardware that is used for transmitting and/or receiving radio signals at frequencies lower than 6 GHz (e.g., frequency range 1 (FR1)), or higher than 6 GHz (e.g., frequency range 2 (FR2)) or millimeter wave (mmWave). In some implementations, an antenna panel includes an array of antenna elements, where each antenna element is connected to hardware, such as a phase shifter that allows a control module to apply spatial parameters for transmission and/or reception of signals. The resulting radiation pattern is called a beam, which may or may not be unimodal and allows the device to amplify signals that are transmitted or received from spatial directions.

In one or more implementations, an antenna panel may be virtualized as an antenna port in the specifications. An antenna panel can be connected to a baseband processing module through a radio frequency (RF) chain for each of transmission (egress) and reception (ingress) directions. A capability of a device in terms of the number of antenna panels, their duplexing capabilities, their beamforming capabilities, and so on, may or may not be transparent to other devices. In some implementations, capability information is communicated via signaling or, in some implementations, capability information is provided to devices without a need for signaling. In the event that such information is available to other devices, it can be used for signaling or local decision making.

In one or more implementations, a device (e.g., a UE, a network node) antenna panel may be a physical or logical antenna array comprising a set of antenna elements or antenna ports that share a common or a significant portion of an RF chain (e.g., in-phase/quadrature (I/Q) modulator, analog to digital (A/D) converter, local oscillator, phase shift network). The device antenna panel (or device panel) may be a logical entity with physical device antennas mapped to the logical entity. The mapping of physical device antennas to the logical entity can be based on device implementation. Communicating (e.g., receiving or transmitting) on at least a subset of antenna elements or antenna ports active for radiating energy (also referred to herein as active elements) of an antenna panel requires biasing or powering of the RF chain, which results in current drain or power consumption in the device associated with the antenna panel, including power amplifier and/or low noise amplifier (LNA) power consumption associated with the antenna elements or antenna ports. The phrase “active for radiating energy,” as used herein is not meant to be limited to a transmit function, but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In one or more implementations, and depending on the particular device implementation, a device panel can have at least one of the following functionalities as an operational role: a unit of an antenna group to control its transmit beam independently, a unit of an antenna group to control its transmission power independently, and/or a unit of an antenna group to control its transmission timing independently. The device panel may be transparent to a gNB. For certain condition(s), a gNB or a network node can assume the mapping between the physical antennas of a device to the logical entity “device panel” may not be changed. For example, the condition may include until the next update or report from a device, or include a duration of time over which the gNB assumes there will be no change to the mapping. A device may report its capability with respect to the device panel to the gNB or network. The device capability can include at least the number of device panels. In an implementation, the device may support uplink (UL) transmission from one beam within a panel, and with multiple panels, more than one beam (e.g., one beam per panel) may be used for UL transmission. In another implementation, more than one beam per panel may be supported or used for UL transmission.

In some described implementations, an antenna port is defined such that the channel over which a symbol on the antenna port is conveyed can be inferred from the channel over which another symbol on the same antenna port is conveyed. Two antenna ports are quasi co-located (QCL) if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and/or spatial receive parameters. Two antenna ports may be quasi-located with respect to a subset of the large-scale properties, and a different subset of large-scale properties can be indicated by a QCL type. The QCL type can indicate which channel properties are the same between the two reference signals (e.g., on the two antenna ports). Thus, the reference signals can be linked to each other with respect to what the UE can assume about their channel statistics or QCL properties. For example, the QCL-type can be one of the following values: QCL-TypeA: {Doppler shift, Doppler spread, average delay, delay spread}; QCL-TypeB: {Doppler shift, Doppler spread}; QCL-TypeC: {Doppler shift, average delay}; QCL-TypeD: {Spatial Rx parameter}.

Spatial receive parameters can include one or more of angle of arrival (AoA,) dominant AoA, average AoA, angular spread, power angular spectrum (PAS) of AoA, average AoD (angle of departure), PAS of AoD, transmit and/or receive channel correlation, transmit and/or receive beamforming, spatial channel correlation, etc. The QCL-TypeA, QCL-TypeB and QCL-TypeC may be applicable for all carrier frequencies, but the QCL-TypeD may be applicable only in higher carrier frequencies (e.g., mmWave, FR2 and beyond), where essentially the UE may not be able to perform omni-directional transmission (i.e., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same receive (Rx) beamforming weights).

As described in this disclosure, an antenna port may be a logical port that corresponds to a beam (resulting from beamforming), or may correspond to a physical antenna on a device. In one or more implementations, a physical antenna can map directly to a single antenna port, in which an antenna port corresponds to an actual physical antenna. Alternately, a set or subset of physical antennas, or an antenna set or antenna array or antenna sub-array, may be mapped to one or more antenna ports after applying complex weights, a cyclic delay, or both to the signal on each physical antenna. The physical antenna set may have antennas from a single module or panel, or from multiple modules or panels. The weights may be fixed as in an antenna virtualization scheme, such as cyclic delay diversity (CDD). The procedure used to derive antenna ports from physical antennas may be specific to a device implementation and transparent to other devices.

In some described implementations, a TCI-state associated with a target transmission can indicate parameters for configuring a quasi-collocation relationship between the target transmission (e.g., a target RS of demodulation reference signal (DMRS) ports of the target transmission during a transmission occasion) and one or more source reference signals (e.g., synchronization signal block (SSB), CSI-RS, and/or sounding reference signal (SRS)) with respect to quasi co-location type parameters indicated in the corresponding TCI state. The TCI describes which reference signals are used as a QCL source, and what QCL properties can be derived from each reference signal. A device can receive a configuration of a plurality of transmission configuration indicator states for a serving cell for transmissions on the serving cell. In some of the described implementations, a TCI state includes at least one source RS to provide a reference (UE assumption) for determining QCL and/or a spatial filter.

In one or more implementations, spatial relation information associated with a target transmission can indicate parameters for configuring a spatial setting between the target transmission and a reference RS (e.g., SSB, CSI-RS, and/or SRS). For example, the device can transmit the target transmission with the same spatial domain filter used for reception of the reference RS (e.g., downlink (DL) RS such as SSB or CSI-RS). In another example, the device may transmit the target transmission with the same spatial domain transmission filter used for the transmission of the reference RS (e.g., UL RS, such as SRS). A device can receive a configuration of multiple spatial relation information configurations for a serving cell for transmissions on the serving cell.

In some described implementations, an UL TCI state is provided if a device is configured with separate DL/UL TCI by RRC signaling. The UL TCI state can include a source reference signal which provides a reference for determining an UL spatial domain transmission filter for the UL transmission (e.g., dynamic-grant or configured-grant based PUSCH, dedicated physical uplink control channel (PUCCH) resources) in a component carrier (CC), or across a set of configured CCs and/or BWPs.

In some described implementations, a joint DL/UL TCI state is provided if the device is configured with joint DL/UL TCI by RRC signaling (e.g., configuration of joint TCI or separate DL/UL TCI is based on RRC signaling). The joint DL/UL TCI state refers to at least a common source reference RS used for determining both the DL QCL information and the UL spatial transmission filter. The source RS determined from the indicated joint (or common) TCI state provides a QCL Type-D indication (e.g., for device-dedicated physical downlink control channel (PDCCH) and/or physical downlink shared channel (PDSCH)) and is used to determine UL spatial transmission filter (e.g., for UE-dedicated physical uplink shared channel (PUSCH) and/or PUCCH) for a CC, or across a set of configured CCs and/or BWPs. In an example, the UL spatial transmission filter is derived from the RS of DL QCL Type-D in the joint TCI state. The spatial setting of the UL transmission may be according to the spatial relation with a reference to the source RS configured with qcl-Type set to “typed” in the joint TCI state. In some of the described implementations, a device may be provided with more than one spatial relations or UL/SL TCI states, and transmit a number of simultaneous transmissions in multiple directions corresponding to the provided more than one spatial relations or UL/SL TCI states (e.g., via multiple panels).

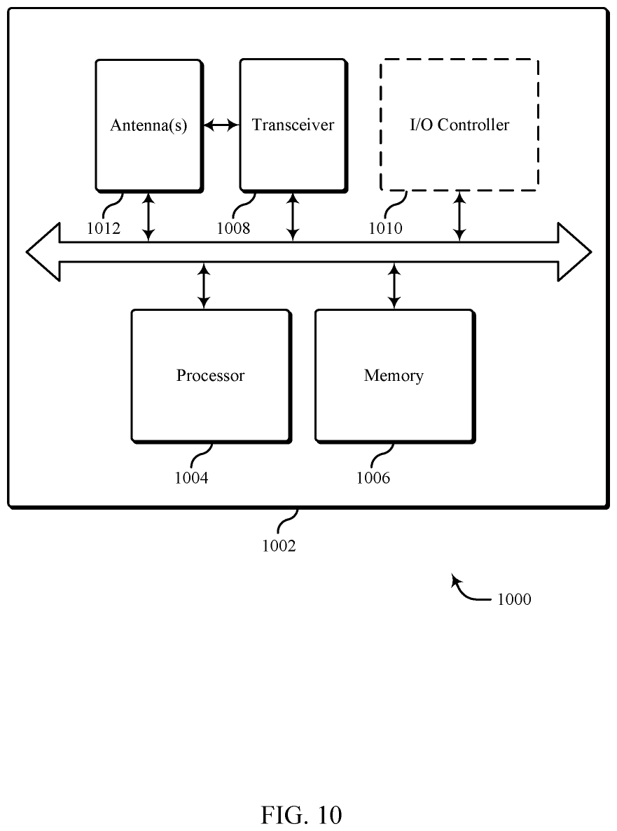

FIG. 10 illustrates an example of a block diagram 1000 of a device 1002 that supports sidelink beamforming configured using PSFCH in accordance with aspects of the present disclosure. The device 1002 may be an example of a UE 104 as described herein. The device 1002 may support wireless communication with one or more network entities 102, UEs 104, or any combination thereof. The device 1002 may include components for bi-directional communications including components for transmitting and receiving communications, such as a processor 1004, a memory 1006, a transceiver 1008, and an I/O controller 1010. These components may be in electronic communication or otherwise coupled (e.g., operatively, communicatively, functionally, electronically, electrically) via one or more interfaces (e.g., buses).

The processor 1004, the memory 1006, the transceiver 1008, or various combinations thereof or various components thereof may be examples of means for performing various aspects of the present disclosure as described herein. For example, the processor 1004, the memory 1006, the transceiver 1008, or various combinations or components thereof may support a method for performing one or more of the operations described herein.

In some implementations, the processor 1004, the memory 1006, the transceiver 1008, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1004 and the memory 1006 coupled with the processor 1004 may be configured to perform one or more of the functions described herein (e.g., executing, by the processor 1004, instructions stored in the memory 1006).

For example, the processor 1004 may support wireless communication at the device 1002 in accordance with examples as disclosed herein. The processor 1004 may be configured as or otherwise support a means for receiving a configuration indicating multiple PSFCH occasions associated with PSSCH reception slots; determining a PSFCH occasion of the multiple PSFCH occasions; selecting a transmit sidelink beam for sidelink feedback during the PSFCH occasion based at least in part on a PSSCH reception slot associated with the PSFCH occasion, the transmit sidelink beam for the sidelink feedback corresponding to a receive sidelink beam for sidelink data during the PSSCH reception slot associated with the PSFCH occasion; and transmitting the sidelink feedback using the selected transmit sidelink beam.

Additionally, the processor 1004 may be configured as or otherwise support any one or combination of the PSFCH occasion is determined based at least in part on the PSSCH reception slot associated with the PSFCH occasion. The PSFCH occasion is determined based at least in part on one or more of the PSSCH reception slots associated with the PSFCH occasion. The sidelink feedback is transmitted as a HARQ-ACK using the selected transmit sidelink beam. The sidelink feedback is transmitted as a CSI report using the selected transmit sidelink beam. The transmit sidelink beam for the PSFCH occasion is selected based at least in part on a one-to-one mapping of the multiple PSFCH occasions to the PSSCH reception slots. The PSFCH occasion is determined based at least in part on an ascending order of the multiple PSFCH occasions in the one-to-one mapping of the multiple PSFCH occasions to the ascending order of the PSSCH reception slots. The method further comprising selecting a subset number of multiple HARQ-ACKs or PSFCHs in frequency domain to be transmitted for an equal number of the PSSCH reception slots in the PSFCH occasion using the selected transmit sidelink beam. The PSFCH occasion is determined as an earliest of a subset number of the multiple PSFCH occasions associated with the PSSCH reception slot. The method further comprising selecting a subset number of multiple HARQ-ACKs or PSFCHs in frequency domain to be transmitted for a greater number of the PSSCH reception slots in the PSFCH occasion using the selected transmit sidelink beam. The method further comprising selecting a subset number of multiple HARQ-ACKs or PSFCHs in frequency domain to be transmitted for a lesser number of the PSSCH reception slots in the PSFCH occasion using the selected transmit sidelink beam. The method further comprising selecting a subset number of multiple HARQ-ACKs or PSFCHs in frequency domain based at least in part on a sidelink priority of the PSSCH reception slot. The transmit sidelink beam is selected based at least in part on the receive sidelink beam being a most recent receive sidelink beam associated with the PSSCH reception slot.

Additionally, or alternatively, the device 1002, in accordance with examples as disclosed herein, may include a processor and a memory coupled with the processor, the processor configured to cause the apparatus to: receive a configuration indicating multiple PSFCH occasions associated with PSSCH reception slots; determine a PSFCH occasion of the multiple PSFCH occasions; select a transmit sidelink beam for sidelink feedback during the PSFCH occasion based at least in part on a PSSCH reception slot associated with the PSFCH occasion, the transmit sidelink beam for the sidelink feedback corresponding to a receive sidelink beam for sidelink data during the PSSCH reception slot associated with the PSFCH occasion; and transmit the sidelink feedback using the selected transmit sidelink beam.

Additionally, the wireless communication at the device 1002 may include any one or combination of the processor is configured to cause the apparatus to determine the PSFCH occasion based at least in part on the PSSCH reception slot associated with the PSFCH occasion. The processor is configured to cause the apparatus to determine the PSFCH occasion based at least in part on one or more of the PSSCH reception slots. The processor is configured to cause the apparatus to transmit the sidelink feedback as a HARQ-ACK using the selected transmit sidelink beam. The processor is configured to cause the apparatus to transmit the sidelink feedback as a CSI report using the selected transmit sidelink beam. The processor is configured to cause the apparatus to select the transmit sidelink beam for the PSFCH occasion based at least in part on a one-to-one mapping of the multiple PSFCH occasions to the PSSCH reception slots. The processor is configured to cause the apparatus to determine the PSFCH occasion based at least in part on an ascending order of the multiple PSFCH occasions in the one-to-one mapping of the multiple PSFCH occasions to the ascending order of the PSSCH reception slots. The processor is configured to cause the apparatus to select a subset number of multiple HARQ-ACKs or PSFCHs in frequency domain to be transmitted for an equal number of the PSSCH reception slots in the PSFCH occasion using the selected transmit sidelink beam. The processor is configured to cause the apparatus to determine the PSFCH occasion as an earliest of a subset number of the multiple PSFCH occasions associated with the PSSCH reception slot. The processor is configured to cause the apparatus to select a subset number of multiple HARQ-ACKs or PSFCHs in frequency domain to be transmitted for a greater number of the PSSCH reception slots in the PSFCH occasion using the selected transmit sidelink beam. The processor is configured to cause the apparatus to select a subset number of multiple HARQ-ACKs or PSFCHs in frequency domain to be transmitted for a lesser number of the PSSCH reception slots in the PSFCH occasion using the selected transmit sidelink beam. The processor is configured to cause the apparatus to select a subset number of multiple HARQ-ACKs or PSFCHs in frequency domain based at least in part on a sidelink priority of the PSSCH reception slot. The processor is configured to cause the apparatus to select the transmit sidelink beam based at least in part on the receive sidelink beam being a most recent receive sidelink beam associated with the PSSCH reception slot.

The processor 1004 of the device 1002, such as a UE 104, may support wireless communication in accordance with examples as disclosed herein. The processor 1004 includes at least one controller coupled with at least one memory, and is configured to or operable to cause the processor to receive a configuration indicating multiple PSFCH occasions associated with PSSCH reception slots; determine a PSFCH occasion of the multiple PSFCH occasions; select a transmit sidelink beam for sidelink feedback during the PSFCH occasion based at least in part on a PSSCH reception slot associated with the PSFCH occasion, the transmit sidelink beam for the sidelink feedback corresponding to a receive sidelink beam for sidelink data during the PSSCH reception slot associated with the PSFCH occasion; and transmit the sidelink feedback using the selected transmit sidelink beam.

The processor 1004 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1004 may be configured to operate a memory array using a memory controller. In some other implementations, a memory controller may be integrated into the processor 1004. The processor 1004 may be configured to execute computer-readable instructions stored in a memory (e.g., the memory 1006) to cause the device 1002 to perform various functions of the present disclosure.

The memory 1006 may include random access memory (RAM) and read-only memory (ROM). The memory 1006 may store computer-readable, computer-executable code including instructions that, when executed by the processor 1004 cause the device 1002 to perform various functions described herein. The code may be stored in a non-transitory computer-readable medium such as system memory or another type of memory. In some implementations, the code may not be directly executable by the processor 1004 but may cause a computer (e.g., when compiled and executed) to perform functions described herein. In some implementations, the memory 1006 may include, among other things, a basic I/O system (BIOS) which may control basic hardware or software operation such as the interaction with peripheral components or devices.

The I/O controller 1010 may manage input and output signals for the device 1002. The I/O controller 1010 may also manage peripherals not integrated into the device M02. In some implementations, the I/O controller 1010 may represent a physical connection or port to an external peripheral. In some implementations, the I/O controller 1010 may utilize an operating system such as iOS®, ANDROID®, MS-DOS®, MS-WINDOWS®, OS/2®, UNIX®, LINUX®, or another known operating system. In some implementations, the I/O controller 1010 may be implemented as part of a processor, such as the processor 1004. In some implementations, a user may interact with the device 1002 via the I/O controller 1010 or via hardware components controlled by the I/O controller 1010.

In some implementations, the device 1002 may include a single antenna 1012. However, in some other implementations, the device 1002 may have more than one antenna 1012 (i.e., multiple antennas), including multiple antenna panels or antenna arrays, which may be capable of concurrently transmitting or receiving multiple wireless transmissions. The transceiver 1008 may communicate bi-directionally, via the one or more antennas 1012, wired, or wireless links as described herein. For example, the transceiver 1008 may represent a wireless transceiver and may communicate bi-directionally with another wireless transceiver. The transceiver 1008 may also include a modem to modulate the packets, to provide the modulated packets to one or more antennas 1012 for transmission, and to demodulate packets received from the one or more antennas 1012.

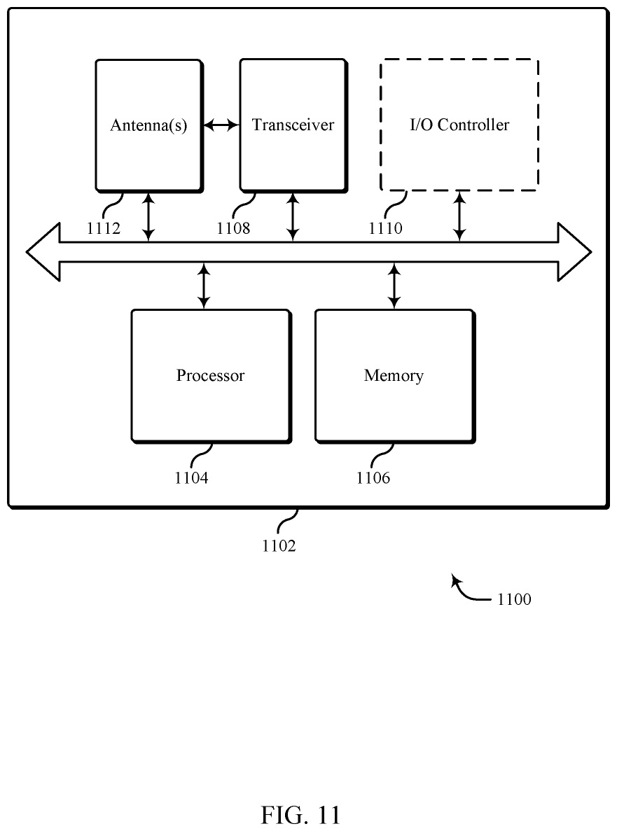

FIG. 11 illustrates an example of a block diagram 1100 of a device 1102 that supports sidelink beamforming configured using PSFCH in accordance with aspects of the present disclosure. The device 1102 may be an example of a gNB (e.g., a network entity (NE) 102) as described herein. The device 1102 may support wireless communication with one or more network entities 102, UEs 104, or any combination thereof. The device 1102 may include components for bi-directional communications including components for transmitting and receiving communications, such as a processor 1104, a memory 1106, a transceiver 1108, and an I/O controller 1110. These components may be in electronic communication or otherwise coupled (e.g., operatively, communicatively, functionally, electronically, electrically) via one or more interfaces (e.g., buses).

The processor 1104, the memory 1106, the transceiver 1108, or various combinations thereof or various components thereof may be examples of means for performing various aspects of the present disclosure as described herein. For example, the processor 1104, the memory 1106, the transceiver 1108, or various combinations or components thereof may support a method for performing one or more of the operations described herein.

In some implementations, the processor 1104, the memory 1106, the transceiver 1108, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1104 and the memory 1106 coupled with the processor 1104 may be configured to perform one or more of the functions described herein (e.g., executing, by the processor 1104, instructions stored in the memory 1106).

For example, the processor 1104 may support wireless communication at the device 1102 in accordance with examples as disclosed herein. The processor 1104 may be configured as or otherwise support a means for transmitting, to a UE, a configuration indicating multiple PSFCH occasions associated with PSSCH reception slots, the UE selects a transmit sidelink beam for sidelink feedback during a PSFCH occasion based at least in part on a PSSCH reception slot associated with the PSFCH occasion; and receiving the sidelink feedback using a receive sidelink beam that corresponds to the selected transmit sidelink beam.

Additionally, the processor 1104 may be configured as or otherwise support any one or combination of the transmit sidelink beam for the sidelink feedback corresponds to the receive sidelink beam during the PSSCH reception slot associated with the PSFCH occasion. The PSFCH occasion is based at least in part on the PSSCH reception slot associated with the PSFCH occasion. The PSFCH occasion is based at least in part on one or more of the PSSCH reception slots. The sidelink feedback is received as a HARQ-ACK using the receive sidelink beam. The sidelink feedback is received as a CSI report using the receive sidelink beam. The transmit sidelink beam for the PSFCH occasion is selected based at least in part on a one-to-one mapping of the multiple PSFCH occasions to the PSSCH reception slots. The PSFCH occasion is determined based at least in part on an ascending order of the multiple PSFCH occasions in the one-to-one mapping of the multiple PSFCH occasions to the ascending order of the PSSCH reception slots. A subset number of multiple HARQ-ACKs or PSFCHs in frequency domain is selected for an equal number of the PSSCH reception slots in the PSFCH occasion. The PSFCH occasion is determined as an earliest of a subset number of the multiple PSFCH occasions associated with the PSSCH reception slot. A subset number of multiple HARQ-ACKs or PSFCHs in frequency domain is selected for a greater number of the PSSCH reception slots in the PSFCH occasion. A subset number of multiple HARQ-ACKs or PSFCHs in frequency domain is selected for a lesser number of the PSSCH reception slots in the PSFCH occasion. A subset number of multiple HARQ-ACKs or PSFCHs in frequency domain is selected based at least in part on a sidelink priority of the PSSCH reception slot. The transmit sidelink beam is selected based at least in part on the receive sidelink beam being a most recent receive sidelink beam associated with the PSSCH reception slot.

Additionally, or alternatively, the device 1102, in accordance with examples as disclosed herein, may include a processor and a memory coupled with the processor, the processor configured to cause the apparatus to: transmit, to a UE, a configuration indicating multiple PSFCH occasions associated with PSSCH reception slots, the UE selects a transmit sidelink beam for sidelink feedback during a PSFCH occasion based at least in part on a PSSCH reception slot associated with the PSFCH occasion; and receive the sidelink feedback using a receive sidelink beam that corresponds to the selected transmit sidelink beam.

Additionally, the wireless communication at the device 1102 may include any one or combination of the transmit sidelink beam for the sidelink feedback corresponds to the receive sidelink beam during the PSSCH reception slot associated with the PSFCH occasion. The PSFCH occasion is based at least in part on the PSSCH reception slot associated with the PSFCH occasion. The PSFCH occasion is based at least in part on one or more of the PSSCH reception slots. The processor is configured to cause the apparatus to receive the sidelink feedback as a HARQ-ACK using the receive sidelink beam. The processor is configured to cause the apparatus to receive the sidelink feedback as a CSI report using the receive sidelink beam. The transmit sidelink beam for the PSFCH occasion is selected based at least in part on a one-to-one mapping of the multiple PSFCH occasions to the PSSCH reception slots. The PSFCH occasion is determined based at least in part on an ascending order of the multiple PSFCH occasions in the one-to-one mapping of the multiple PSFCH occasions to the ascending order of the PSSCH reception slots. A subset number of multiple HARQ-ACKs or PSFCHs in frequency domain is selected for an equal number of the PSSCH reception slots in the PSFCH occasion. The PSFCH occasion is determined as an earliest of a subset number of the multiple PSFCH occasions associated with the PSSCH reception slot. A subset number of multiple HARQ-ACKs or PSFCHs in frequency domain is selected for a greater number of the PSSCH reception slots in the PSFCH occasion. A subset number of multiple HARQ-ACKs or PSFCHs in frequency domain is selected for a lesser number of the PSSCH reception slots in the PSFCH occasion. A subset number of multiple HARQ-ACKs or PSFCHs in frequency domain is selected based at least in part on a sidelink priority of the PSSCH reception slot. The transmit sidelink beam is selected based at least in part on the receive sidelink beam being a most recent receive sidelink beam associated with the PSSCH reception slot.

The processor 1104 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1104 may be configured to operate a memory array using a memory controller. In some other implementations, a memory controller may be integrated into the processor 1104. The processor 1104 may be configured to execute computer-readable instructions stored in a memory (e.g., the memory 1106) to cause the device 1102 to perform various functions of the present disclosure.

The memory 1106 may include random access memory (RAM) and read-only memory (ROM). The memory 1106 may store computer-readable, computer-executable code including instructions that, when executed by the processor 1104 cause the device 1102 to perform various functions described herein. The code may be stored in a non-transitory computer-readable medium such as system memory or another type of memory. In some implementations, the code may not be directly executable by the processor 1104 but may cause a computer (e.g., when compiled and executed) to perform functions described herein. In some implementations, the memory 1106 may include, among other things, a basic I/O system (BIOS) which may control basic hardware or software operation such as the interaction with peripheral components or devices.

The I/O controller 1110 may manage input and output signals for the device 1102. The I/O controller 1110 may also manage peripherals not integrated into the device 1102. In some implementations, the I/O controller 1110 may represent a physical connection or port to an external peripheral. In some implementations, the I/O controller 1110 may utilize an operating system such as iOS®, ANDROID®, MS-DOS®, MS-WINDOWS®, OS/2®, UNIX®, LINUX®, or another known operating system. In some implementations, the I/O controller 1110 may be implemented as part of a processor, such as the processor 1104. In some implementations, a user may interact with the device 1102 via the I/O controller 1110 or via hardware components controlled by the I/O controller 1110.

In some implementations, the device 1102 may include a single antenna 1112. However, in some other implementations, the device 1102 may have more than one antenna 1112 (i.e., multiple antennas), including multiple antenna panels or antenna arrays, which may be capable of concurrently transmitting or receiving multiple wireless transmissions. The transceiver 1108 may communicate bi-directionally, via the one or more antennas 1112, wired, or wireless links as described herein. For example, the transceiver 1108 may represent a wireless transceiver and may communicate bi-directionally with another wireless transceiver. The transceiver 1108 may also include a modem to modulate the packets, to provide the modulated packets to one or more antennas 1112 for transmission, and to demodulate packets received from the one or more antennas 1112.

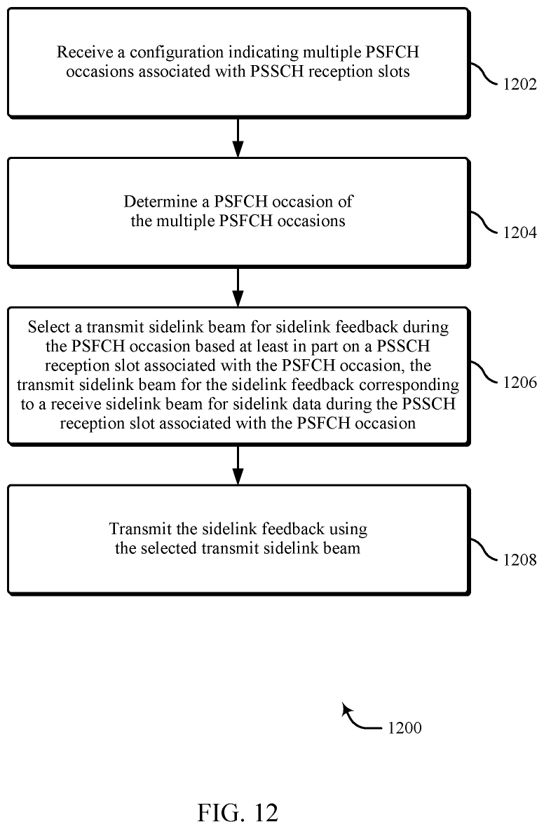

FIG. 12 illustrates a flowchart of a method 1200 that supports sidelink beamforming configured using PSFCH in accordance with aspects of the present disclosure. The operations of the method 1200 may be implemented by a device or its components as described herein. For example, the operations of the method 1200 may be performed by a UE 104 as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1202, the method may include receiving a configuration indicating multiple PSFCH occasions associated with PSSCH reception slots. The operations of 1202 may be performed in accordance with examples as described herein. In some implementations, aspects of the operations of 1202 may be performed by a device as described with reference to FIG. 1.

At 1204, the method may include determining a PSFCH occasion of the multiple PSFCH occasions. The operations of 1204 may be performed in accordance with examples as described herein. In some implementations, aspects of the operations of 1204 may be performed by a device as described with reference to FIG. 1.

At 1206, the method may include selecting a transmit sidelink beam for sidelink feedback during the PSFCH occasion based at least in part on a PSSCH reception slot associated with the PSFCH occasion, the transmit sidelink beam for the sidelink feedback corresponding to a receive sidelink beam for sidelink data during the PSSCH reception slot associated with the PSFCH occasion. The operations of 1206 may be performed in accordance with examples as described herein. In some implementations, aspects of the operations of 1206 may be performed by a device as described with reference to FIG. 1.

At 1208, the method may include transmitting the sidelink feedback using the selected transmit sidelink beam. The operations of 1208 may be performed in accordance with examples as described herein. In some implementations, aspects of the operations of 1208 may be performed by a device as described with reference to FIG. 1.

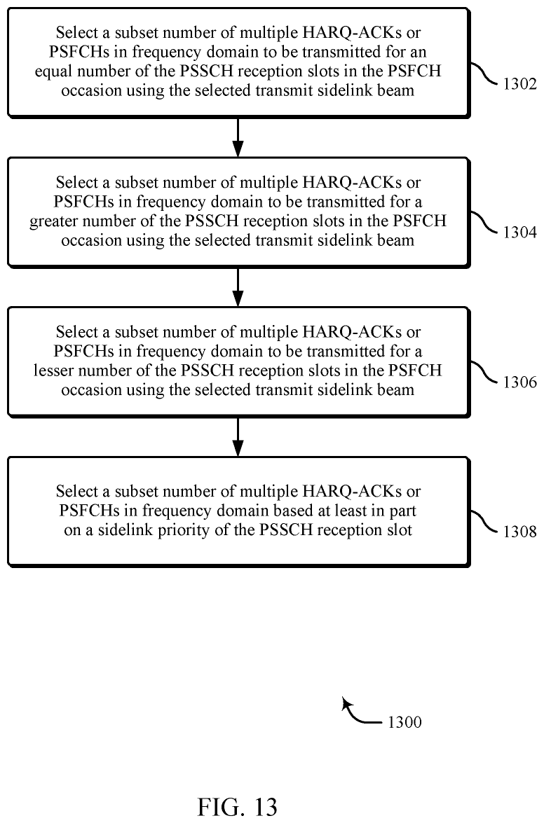

FIG. 13 illustrates a flowchart of a method 1300 that supports sidelink beamforming configured using PSFCH in accordance with aspects of the present disclosure. The operations of the method 1300 may be implemented by a device or its components as described herein. For example, the operations of the method 1300 may be performed by a UE 104 as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1302, the method may include selecting a subset number of multiple HARQ-ACKs or PSFCHs in frequency domain to be transmitted for an equal number of the PSSCH reception slots in the PSFCH occasion using the selected transmit sidelink beam. The operations of 1302 may be performed in accordance with examples as described herein. In some implementations, aspects of the operations of 1302 may be performed by a device as described with reference to FIG. 1.

At 1304, the method may include selecting a subset number of multiple HARQ-ACKs or PSFCHs in frequency domain to be transmitted for a greater number of the PSSCH reception slots in the PSFCH occasion using the selected transmit sidelink beam. The operations of 1304 may be performed in accordance with examples as described herein. In some implementations, aspects of the operations of 1304 may be performed by a device as described with reference to FIG. 1.

At 1306, the method may include selecting a subset number of multiple HARQ-ACKs or PSFCHs in frequency domain to be transmitted for a lesser number of the PSSCH reception slots in the PSFCH occasion using the selected transmit sidelink beam. The operations of 1306 may be performed in accordance with examples as described herein. In some implementations, aspects of the operations of 1306 may be performed by a device as described with reference to FIG. 1.

At 1308, the method may include selecting a subset number of multiple HARQ-ACKs or PSFCHs in frequency domain based at least in part on a sidelink priority of the PSSCH reception slot. The operations of 1308 may be performed in accordance with examples as described herein. In some implementations, aspects of the operations of 1308 may be performed by a device as described with reference to FIG. 1.

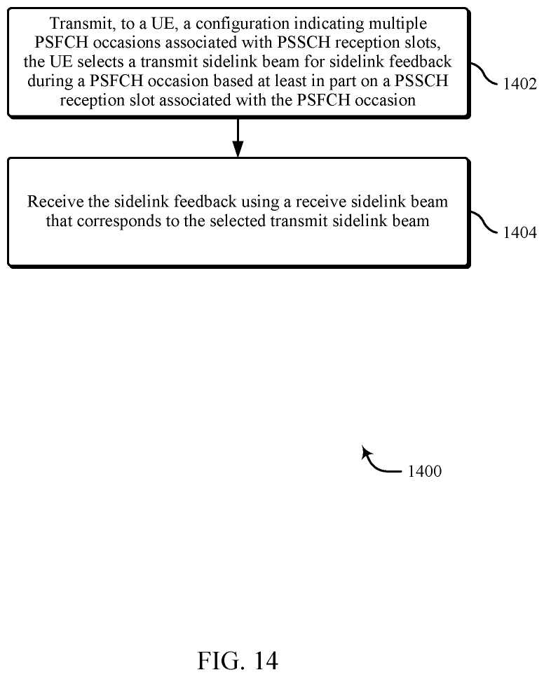

FIG. 14 illustrates a flowchart of a method 1400 that supports sidelink beamforming configured using PSFCH in accordance with aspects of the present disclosure. The operations of the method 1400 may be implemented by a device or its components as described herein. For example, the operations of the method 1400 may be performed by a gNB (e.g., a network entity 102) as described with reference to FIGS. 1 through 11. In some implementations, the device may execute a set of instructions to control the function elements of the device to perform the described functions. Additionally, or alternatively, the device may perform aspects of the described functions using special-purpose hardware.

At 1402, the method may include transmitting, to a UE, a configuration indicating multiple PSFCH occasions associated with PSSCH reception slots, the UE selects a transmit sidelink beam for sidelink feedback during a PSFCH occasion based at least in part on a PSSCH reception slot associated with the PSFCH occasion. The operations of 1402 may be performed in accordance with examples as described herein. In some implementations, aspects of the operations of 1402 may be performed by a device as described with reference to FIG. 1.

At 1404, the method may include receiving the sidelink feedback using a receive sidelink beam that corresponds to the selected transmit sidelink beam. The operations of 1404 may be performed in accordance with examples as described herein. In some implementations, aspects of the operations of 1404 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
receive a configuration indicating multiple physical sidelink feedback channel (PSFCH) occasions associated with physical sidelink shared channel (PSSCH) reception slots;
determine a PSFCH occasion of the multiple PSFCH occasions;
select a transmit sidelink beam for sidelink feedback during the PSFCH occasion based at least in part on a PSSCH reception slot associated with the PSFCH occasion, the transmit sidelink beam for the sidelink feedback corresponding to a receive sidelink beam for sidelink data during the PSSCH reception slot associated with the PSFCH occasion; and
transmit the sidelink feedback using the selected transmit sidelink beam.

2. The UE of claim 1, wherein the at least one processor is operable to cause the UE to determine the PSFCH occasion based at least in part on the PSSCH reception slot associated with the PSFCH occasion.

3. The UE of claim 1, wherein the at least one processor is operable to cause the UE to determine the PSFCH occasion based at least in part on one or more of the PSSCH reception slots.

4. The UE of claim 1, wherein the at least one processor is operable to cause the UE to transmit the sidelink feedback as a hybrid automatic repeat request acknowledgment (HARQ-ACK) using the selected transmit sidelink beam.

5. The UE of claim 1, wherein the at least one processor is operable to cause the UE to transmit the sidelink feedback as a channel state information (CSI) report using the selected transmit sidelink beam.

6. The UE of claim 1, wherein the at least one processor is operable to cause the UE to select the transmit sidelink beam for the PSFCH occasion based at least in part on a one-to-one mapping of the multiple PSFCH occasions to the PSSCH reception slots.

7. The UE of claim 6, wherein the at least one processor is operable to cause the UE to determine the PSFCH occasion based at least in part on an ascending order of the multiple PSFCH occasions in the one-to-one mapping of the multiple PSFCH occasions to the ascending order of the PSSCH reception slots.

8. The UE of claim 1, wherein the at least one processor is operable to cause the UE to select a subset number of multiple hybrid automatic repeat request acknowledgments (HARQ-ACKs) or PSFCHs in frequency domain to be transmitted for an equal number of the PSSCH reception slots in the PSFCH occasion using the selected transmit sidelink beam.

9. The UE of claim 1, wherein the at least one processor is operable to cause the UE to determine the PSFCH occasion as an earliest of a subset number of the multiple PSFCH occasions associated with the PSSCH reception slot.

10. The UE of claim 1, wherein the at least one processor is operable to cause the UE to select a subset number of multiple hybrid automatic repeat request acknowledgments (HARQ-ACKs) or PSFCHs in frequency domain to be transmitted for a greater number of the PSSCH reception slots in the PSFCH occasion using the selected transmit sidelink beam.

11. The UE of claim 1, wherein the at least one processor is operable to cause the UE to select a subset number of multiple hybrid automatic repeat request acknowledgments (HARQ-ACKs) or PSFCHs in frequency domain to be transmitted for a lesser number of the PSSCH reception slots in the PSFCH occasion using the selected transmit sidelink beam.

12. The UE of claim 1, wherein the at least one processor is operable to cause the UE to select a subset number of multiple hybrid automatic repeat request acknowledgments (HARQ-ACKs) or PSFCHs in frequency domain based at least in part on a sidelink priority of the PSSCH reception slot.

13. The UE of claim 1, wherein the at least one processor is operable to cause the UE to select the transmit sidelink beam based at least in part on the receive sidelink beam being a most recent receive sidelink beam associated with the PSSCH reception slot.

14. (canceled)

15. A network entity (NE) for wireless communication, comprising:
at least one memory; and
at least one processor coupled with the at least one memory and operable to cause the NE to:
transmit, to a user equipment (UE), a configuration indicating multiple physical sidelink feedback channel (PSFCH) occasions associated with physical sidelink shared channel (PSSCH) reception slots, wherein the UE selects a transmit sidelink beam for sidelink feedback during a PSFCH occasion based at least in part on a PSSCH reception slot associated with the PSFCH occasion; and
receive the sidelink feedback using a receive sidelink beam that corresponds to the selected transmit sidelink beam.

16. The NE of claim 15, wherein the transmit sidelink beam for the sidelink feedback corresponds to the receive sidelink beam during the PSSCH reception slot associated with the PSFCH occasion.

17. The NE of claim 15, wherein the PSFCH occasion is based at least in part on the PSSCH reception slot associated with the PSFCH occasion.

18. The NE of claim 15, wherein the PSFCH occasion is based at least in part on one or more of the PSSCH reception slots.

19. The NE of claim 15, wherein the at least one processor is operable to cause the NE to receive the sidelink feedback as a hybrid automatic repeat request acknowledgment (HARQ-ACK) using the receive sidelink beam.

20. A method performed by a user equipment (UE), comprising:
receiving a configuration indicating multiple physical sidelink feedback channel (PSFCH) occasions associated with physical sidelink shared channel (PSSCH) reception slots;
determining a PSFCH occasion of the multiple PSFCH occasions;
selecting a transmit sidelink beam for sidelink feedback during the PSFCH occasion based at least in part on a PSSCH reception slot associated with the PSFCH occasion, the transmit sidelink beam for the sidelink feedback corresponding to a receive sidelink beam for sidelink data during the PSSCH reception slot associated with the PSFCH occasion; and
transmitting the sidelink feedback using the selected transmit sidelink beam.

21. A method performed by a network entity (NE), the method comprising:
transmitting, to a user equipment (UE), a configuration indicating multiple physical sidelink feedback channel (PSFCH) occasions associated with physical sidelink shared channel (PSSCH) reception slots, wherein the UE selects a transmit sidelink beam for sidelink feedback during a PSFCH occasion based at least in part on a PSSCH reception slot associated with the PSFCH occasion; and
receiving the sidelink feedback using a receive sidelink beam that corresponds to the selected transmit sidelink beam.
